(19) United States
(12) Patent Application Publication
(10) Pub. No.: US 2012/0213896 A1
(43) Pub. Date: Aug. 23, 2012

(54) Ovenable Cook-In Film Providing Decreased Protein Adhesion

(75) Inventors: Joseph E. Owensby, Spartanburg, SC (US); Amy T. Hunter, Greenville, SC (US)

(73) Assignee: CRYOVAC, INC., Duncan, SC (US)

(21) Appl. No.: 13/032,916

(22) Filed: Feb. 23, 2011

(51) Int. Cl. B65B 29/08; C08L 77/06; C08L 1/00; B65D 81/34

(52) U.S. Cl. 426/113; 426/394; 523/100

(57) ABSTRACT

The presently disclosed subject matter relates generally to packaging films that exhibit favorable sealing characteristics and reduced adhesion to meat at high temperatures. The presently disclosed subject matter also relates to packages constructed from such films and methods of using the films in high temperature applications.

### FIELD OF THE INVENTION

The presently disclosed subject matter relates generally to packaging films that exhibit favorable sealing characteristics and reduced adhesion to protein at high temperatures. The presently disclosed subject matter also relates to packages constructed from such films and methods of using the films in high temperature applications.

### BACKGROUND

The food packaging industry employs bags, pouches, and the like constructed from packaging films that can be used in cook-in applications, i.e., uses in which a food product is packaged and cooked inside a film. Thus, the terms “cook-in” and “retortable” can refer to packaging materials structurally capable of withstanding exposure to cook-in time-temperature conditions while surrounding a food product. In some embodiments, cook-in time-temperature conditions can refer to cooking in a conventional oven and/or direct contact heating (for example, using a double-sided grill) at 350° F. to 400° F. for 3 hours or less. Cook-in packaging materials also maintain seal integrity, i.e., any heat seals maintain their reliability during cook-in.

The cook-in concept is particularly beneficial because it avoids the need for the consumer to handle raw meat, which consumers can find disagreeable. Moreover, the handling of raw meat is a growing concern from a food safety perspective, and a pre-packaged cook-in food product reduces the risk of contamination. Cook-in packages also increase consumer convenience since cooking instructions can be provided in association with the package. In addition, the pre-packaging of food products can be used as a mechanism of portion control, which is becoming desirable in an increasingly health-conscious marketplace.

However, prior art films used in cook-in applications tend to stick or adhere to proteins in the packaged food products. Particularly, prior art films encounter problems with too much adhesion to the food product during cooking. As the film is removed, it pulls off a portion of the food product, resulting in damage and decreased palatability.

To this end, a packaging film suitable for cook-in applications that exhibits reduced adhesion of the film to the packaged product during and after cooking is desirable.

### SUMMARY

In some embodiments, the presently disclosed subject matter is directed to a cook-in film comprising a sealant layer comprising between about 5% and 25% cellulose particles (based on the total weight of the layer) and between about 75% and 95% nylon (based on the total weight of the layer). In the disclosed film, the amount of cellulose particles is effective to substantially preclude adherence of the sealant layer to a protein-containing product in contact with the layer in conditions of from about 200° F. to about 450° F. for about 10 minutes to about 180 minutes.

In some embodiments, the presently disclosed subject matter is directed to a cook-in film comprising a sealant layer comprising between about 5% and 25% cellulose particles (based on the total weight of the layer), between about 74% and 94% nylon (based on the total weight of the layer), and between about 0.25% and 10% non-stick additive (based on the total weight of the layer). In the disclosed film, the amount of cellulose particles and non-stick additive is effective to substantially preclude adherence of the sealant layer to a protein-containing product in contact with the layer in conditions of from about 200° F. to about 450° F. for about 10 minutes to about 180 minutes.

In some embodiments, the presently disclosed subject matter is directed to a package comprising a protein-containing product positioned inside the package, wherein the package comprises a cook-in film comprising a sealant layer. In some embodiments, the sealant layer comprises between about 5% and about 25% cellulose particles (based on the total weight of the layer) and between about 75% and about 95% nylon (based on the total weight of the layer). In some embodiments, the amount of cellulose particles is effective to substantially preclude adherence of the sealant layer to the protein-containing product in contact with the layer in conditions of from about 200° F. to about 450° F. for about 10 minutes to about 180 minutes.

In some embodiments, the presently disclosed subject matter is directed to a package comprising a protein-containing product positioned inside the package, wherein the package comprises a cook-in film comprising a sealant layer. In some embodiments, the sealant layer comprises between about 5% and 25% cellulose particles (based on the total weight of the layer), between about 74% and 94% nylon (based on the total weight of the layer), and between about 0.25% and 10% non-stick additive (based on the total weight of the layer). In some embodiments, the amount of cellulose particles and non-stick additive is effective to substantially preclude adherence of the sealant layer to the protein-containing product in contact with the layer in conditions of from about 200° F. to about 450° F. for about 10 minutes to about 180 minutes.

In some embodiments, the presently disclosed subject matter is directed to a method of cooking a food product using a cook-in package. Particularly, the method comprises preparing a protein-containing product and packaging the protein-containing product in a cook-in package constructed from a film comprising a sealant layer. In some embodiments, the sealant layer comprises: between about 5% and about 25% cellulose particles (based on the total weight of the layer) and between about 75% and about 95% nylon (based on the total weight of the layer). The method further comprises sealing the package closed such that the protein-containing product is surrounded by the film and cooking the food product by subjecting the package to a temperature of from about 200° F. to about 450° F. for a period of from about 10 minutes to about 180 minutes.

In some embodiments, the presently disclosed subject matter is directed to a method of cooking a food product using a cook-in package. Specifically, the method comprises preparing a protein-containing product and packaging the protein-containing product in a cook-in package constructed from a film comprising a sealant layer. In some embodiments, the sealant layer comprises between about 5% and about 25% cellulose particles (based on the total weight of the layer), between about 74% and about 94% nylon (based on the total weight of the layer), and between about 0.25% and 10% non-stick additive (based on the total weight of the layer). The method further comprises sealing the package closed such that the protein-containing product is surrounded by the film and cooking the food product by subjecting the package to a temperature of from about 200° F. to about 450° F. for a period of from about 10 minutes to about 180 minutes.

### BRIEF DESCRIPTION OF THE DRAWINGS

FIG. 1 is a cross-sectional view of a monolayer film in accordance with some embodiments of the presently disclosed subject matter.

FIG. 2 is a cross-sectional view of a 4 layer film in accordance with some embodiments of the presently disclosed subject matter.

FIG. 3a is a top plan view of one embodiment of a package formed from a film of the presently disclosed subject matter.

FIG. 3b is a cross-sectional view of the package of FIG. 3a, taken along line 3b-3b.

### DETAILED DESCRIPTION

### I. General Considerations

The presently disclosed subject matter relates generally to films useful for packaging a wide variety of products, including (but not limited to) protein-containing food products, such as meat. More specifically, the presently disclosed subject matter relates to packaging films that are suitable for constructing packages that can be used for high temperature cook-in applications. To this end, in some embodiments, the disclosed packages can withstand temperatures greater than the boiling point of water, i.e., 212° F.; in some embodiments, greater than 300° F.; and in some embodiments, up to about 350° F. to about 400° F. The disclosed package can be placed directly into a high temperature environment, such as into a conventional oven or on a double-sided grill apparatus to cook the product contained within the film. In addition, the disclosed films have excellent heat-sealing properties and heat-seal integrity under cook-in conditions.

The disclosed film comprises incorporating cellulose particles or similar materials into the sealant layer. In some embodiments, the cellulose particles can be about 1% to about 50%; in some embodiments, between about 3% and 40%; and in some embodiments, between about 5% and 25% of the total weight of the sealant layer. In some embodiments, the disclosed sealant layer can further comprise one or more additional non-stick additives (such as natural oils, for example). As a result of the cellulose particles incorporated into the film (either alone or with the addition of the non-stick additive), a reduction in the adherence of the cooked product to the film is achieved. In some embodiments, adherence of the cooked product to the film is eliminated.

### II. Definitions

While the following terms are believed to be understood by one of ordinary skill in the art, the following definitions are set forth to facilitate explanation of the presently disclosed subject matter.

Unless defined otherwise, all technical and scientific terms used herein have the same meaning as commonly understood by one of ordinary skill in the art to which the presently disclosed subject matter pertains. Although any methods, devices, and materials similar or equivalent to those described herein can be used in the practice or testing of the presently disclosed subject matter, representative methods, device, and materials are now described.

Following long-standing patent law convention, the terms “a”, “an”, and “the” refers to “one or more” when used in the subject specification, including the claims. Thus, for example, reference to “a film” (e.g., “a cook-in film”) includes a plurality of such films, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, temperature, concentration, or percentage can encompass variations of, in some embodiments ±20%, in some embodiments ±10%, in some embodiments ±5%, in some embodiments ±1%, in some embodiments ±0.5%, and in some embodiments to ±0.1%, from the specified amount, as such variations are appropriate in the disclosed package and methods.

As used herein, the phrase “abuse layer” refers to an outer film layer and/or an inner film layer, so long as the film layer serves to resist abrasion, puncture, and other potential causes of reduction of package integrity, as well as potential causes of reduction of package appearance quality. Abuse layers can comprise any polymer so long as the polymer contributes to achieving an integrity goal and/or an appearance goal. In some embodiments, abuse layers comprise polymer having a modulus of at least 10⁷ Pascals at room temperature. In some embodiments, the abuse layer comprises at least one member selected from the group comprising polyamide, ethylene/propylene copolymer; more preferably, nylon 6, nylon 6/6, amorphous nylon, polyethylene terephthalate (“PET”), and ethylene/propylene copolymer.

As used herein, the term “adhesive” refers to polymeric adhesive. In some embodiments, the polymeric adhesive can be an olefin polymer or copolymer with an anhydride functionality grafted thereon and/or copolymerized therewith and/or blended therewith. Alternatively or in addition, in some embodiments, the adhesive can be an anhydride grafted tie layer (such as, but not limited to, Bynel® 91E825, available from E.I. DuPont de Nemours and Company, Wilmington, Del., United States of America) and can be used to tie together two layers (such as, for example layers comprising PET and/or nylon). However, any of a variety of commonly used adhesives can be used.

As used herein, the term “barrier” and/or the phrase “barrier layer”, as applied to films and/or layers of the disclosed package, are used with reference to the ability of a film or layer to serve as a barrier to one or more gases. In the packaging art, barrier layers can include, but are not limited to, ethylene/vinyl alcohol copolymer, polyvinylidene chloride, polyalkylene carbonate, polyamide, polyethylene naphthalate, polyester, polyacrylonitrile, and combinations thereof, as known to those of skill in the art.

As used herein, the phrase “bulk layer” refers to any layer of a film that is present for the purpose of increasing the abuse-resistance, toughness, modulus, etc., of a multilayer film. Bulk layers generally comprise polymers that are inexpensive relative to other polymers in the film that provide some specific purpose unrelated to abuse-resistance, modulus, etc. In some embodiments, bulk layers comprise polyolefin; in some embodiments, at least one member selected from the group comprising ethylene/alpha-olefin copolymer, ethylene/alpha-olefin copolymer plastomer, low density polyethylene, and linear low density polyethylene.

The term “carbon nanotube” as used herein refers to a hollow article composed primarily of carbon atoms. To this end, the term “carbon nanotube” can broadly refer to carbon nanotubes, as well as other generally cylindrically-shaped carbon nanostructures, such as nanowires, nanowhiskers, nanofibers, nanofilaments, and the like.

As used herein, the term “cellulose” refers to polymers that are typically of the general formula C₁₂ₙH₁₀ₙO₅ₙ, where “n” is the number of repeating units in the polymer chain. Natural sources of cellulose include deciduous and coniferous trees, cotton, flax, esparto grass, milkweed, straw, jute, hemp, and begasse. The term “cellulose” also refers to celluloses that have been modified with regard to molecular weight and/or branching as well as celluloses that have been chemically modified to attach chemical functionality (such as carboxy, hydroxyl, hydroxyalkylene, or carboxyalkylene groups). In some embodiments, useful cellulose materials include those that are approved, or could receive approval, for food contact by a relevant governmental agency.

As used herein, the term “cellulose particles” includes materials comprising at least 50 weight % cellulose based on the weight of the particle material, where “particle” includes configurations such as fibers, finely chopped fibers, and powders. For example, in some embodiments, exemplary cellulose particles can include (but are not limited to) cotton fibers, fibers derived from high purity alpha wood pulp, softwood and/or hardwood fibers (e.g., having fiber lengths of from 10 to 70 microns).

The term “ceramic particle” as used herein refers to particle constructed from a solid substance other than a metal. For example, in some embodiments, the ceramic particles can include (but are not limited to) cordierite, alumina, mullite, lithium aluminum silicate, aluminum titanate, titania, zirconia, zirconium phosphate, zeolite, silicon nitride, aluminum nitride, silicon carbide, calcium phosphate, hydroxyapatite, and combinations thereof.

As used herein, the terms “comprises,” “comprising,” “includes,” “including,” or any other variation thereof are intended to cover a non-exclusive inclusion. For example, a process, method, article, or apparatus that comprises a list of elements is not necessarily limited to only those elements but can include other elements not expressly listed or inherent to such process, method, article, or apparatus.

As used herein, the term “cook-in” refers to the process of cooking a product packaged in a material capable of withstanding exposure to cooking conditions while containing the food product. For example, in some embodiments, cook-in conditions can include direct contact heating (i.e., between heated cooking plates, such as a George Foreman Grill®) at temperatures from 300-400° F. for up to about 2 hours. Alternatively, in some embodiments, the term “cook-in” can include (without limitation) cooking in a conventional oven, convection oven, microwave oven, susceptor used in a microwave oven, induction cooking device, and/or on a panini grill. Cook-in packaged foods are essentially foods that can be directly transferred to the consumer in pre-packaged form. Cook-in packaging materials maintain seal integrity and in the case of multilayer films can be delamination resistant. In some embodiments, cook-in films are heat shrinkable under cook-in conditions to form a tightly fitting package.

As used herein, the term “core layer” refers to the central layer or layers of a multilayered film.

The term “directly adjacent” as used herein refers to adjacent layers that are in contact with another layer without any tie layer, adhesive, or other layer therebetween.

As used herein, the term “film” can be used in a generic sense to include plastic web, regardless of whether it is film or sheet.

The terms “first layer”, “second layer”, and the like as used herein are generally indicative of the manner in which a multilayer film structure is built up. That is, in general, the first layer can be present without any of the additional layers described, or the first and second layers can be present without any of the additional layers described, etc.

As used herein, the phrase “food-contact layer” refers to a layer of a film that is in direct contact with the food-containing product packaged in the film. The food-contact layer is an outer layer to be in direct contact with the food product. The food-contact layer is an inside layer in the sense that in the packaged food product, the food-contact layer is the innermost film layer in direct contact with the food.

As used herein, the terms “inner layer” and “internal layer” refer to any layer of a multilayer film having both of its principal surfaces directly adhered to another layer of the film.

As used herein, the term “lamination”, the term “laminate”, and the phrase “laminated film”, refer to the process and resulting product made by bonding together two or more layers of film or other materials. Lamination can be accomplished by joining layers with adhesives, joining with heat and pressure, and/or spread coating and extrusion coating. The term “laminate” is also inclusive of coextruded multilayer films comprising one or more tie layers.

The term “multilayer film” as used herein refers to a thermoplastic material, generally in sheet or web form, having one or more layers formed from polymeric or other materials that are bonded together by any conventional or suitable method, including one or more of the following: coextrusion, extrusion coating, lamination, vapor deposition coating, solvent coating, emulsion coating, and/or suspension coating.

The terms “nylon” or “polyamide” as used herein refer to polymers having amide linkages along the molecular chain. Particularly, such terms encompass both polymers comprising repeating units derived from monomers (such as caprolactam) that polymerize to form a polyamide, as well as polymers of diamines and diacids, and copolymers of two or more amide monomers (including polyamide terpolymers, sometimes referred to in the art as “copolyamides”). The terms “nylon” and “polyamide” also include (but are not limited to) those aliphatic polyamides or copolyamides commonly referred to as nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/6I, nylon 10/10, nylon 11, nylon 12, nylon 6/12, modifications thereof and blends thereof. The terms “nylon” and “polyamide” also include crystalline, partially crystalline, amorphous, aromatic, and partially aromatic polyamides. Examples of partially crystalline aromatic polyamides include meta-xylylene adipamide (MXD6), copolymers such as MXD6/MXDI, 66/MXD10, and the like. Examples of amorphous polyamides nonexclusively include poly(hexamethylene isophthalamide-co-terephthalamide) (PA-6I/6T), poly(hexamethylene isophthalamide) (PA-6I), and other polyamides abbreviated as PA-MXDI, PA-6/MXDT/I, PA-6,6/6I and the like. Amorphous polyamides can also include polyamides that are prepared from the following diamines: hexamethylenediamine, 2-methylpentamethylenediamine, 2,2,4-trimethylhexamethylenediamine, 2,4,4-trimethylhexamethylenediamine, bis(4-aminocyclohexyl)methane, 2,2-bis(4-aminocyclohexyl)isopropylidine, 1,4-diaminocyclohexane, 1,3-diaminocyclohexane, meta-xylylenediamine, 1,5-diaminopentane, 1,4-diaminobutane, 1,3-diaminopropane, 2-ethyldiaminobutane, 1,4-diaminomethylcyclohexane, p-xylylenediamine, m-phenylenediamine, p-phenylenediamine, and alkyl substituted m-phenylenediamine and p-phenylenediamine. Further, amorphous polyamides can also refer to those prepared from the following dicarboxylic acids: isophthalic acid, terephthalic acid, alkyl substituted iso- and ter-ephthalic acid, adipic acid, sebacic acid, butane dicarboxylic acid, and the like. The diamines and diacids mentioned above can be combined as desired, provided the resulting polyamide is amorphous. Further, the nylons and polyamides suitable for use with the presently disclosed subject matter are approved for use in producing packages intended for use in processing, handling, and packaging food, including homopolymers, copolymers and mixtures of the nylon materials described in 21 C.F.R. 177.1500 et al., incorporated by reference herein in its entirety.

As used herein, the term “outer layer” refers to any film layer having less than two of its principal surfaces directly adhered to another layer of the film. The phrase is inclusive of monolayer and multilayer films. In multilayer films, there are two outer layers, each of which has a principal surface adhered to only one other layer of the multilayer film. In monolayer films, there is only one layer, which, of course, is an outer layer in that neither of its two principal surfaces is adhered to another layer of the film.

As used herein, the term “package” refers to an object of manufacture that can be in the form of a web (e.g., monolayer or multilayer films, monolayer or multilayer sheets), bag, shrink bag, pouch, casing, tray, lidded tray, overwrapped tray, shrink package, vacuum skin package, flow wrap package, thermoformed package, packaging insert, or combinations thereof. It will be appreciated by those skilled in the art that such packages can include flexible, rigid, or semi-rigid materials and can be heat shrinkable or non-heat shrinkable, and oriented or non-oriented.

As used herein, the term “polymer” refers to the product of a polymerization reaction, and can be inclusive of homopolymers, copolymers, terpolymers, etc. In some embodiments, the layers of a film can consist essentially of a single polymer, or can have still additional polymers together therewith, i.e., blended therewith.

As used herein, the terms “product” or “packaged product” can include protein-containing food products (e.g., ground or processed meat products including fresh red meat, poultry, pork, sausage, lamb, goat, horse, fish, and the like). The food product can contain at least about each of the following weight of proteinaceous food: 10, 15, 20, 25, 30, 35, 40, 45, 50, 55, 60, 65, 70, 75, 80, 85, 90, 95, 98, and 100.

As used herein, the term “retortable” refers to a film that can be formed into a pouch, filled with a product, sealed, and subjected to conditions of high temperature (between about 200° F. and about 450° F.), for a period of time of between 10 minutes and 3 hours to cook and/or heat the product. Thus, in some embodiments, the retortable package can be subjected to temperatures of about 200° F., 225° F., 250° F., 275° F., 300° F., 325° F., 350° F., 375° F., 400° F., 425° F., or 450° F. (and all temperatures in between, such as 201° F., 202° F., 203° F., etc.) for a period of time of about 10, 20, 30, 40, 50, 60, 70, 80, 90, 100, 110, 120, 130, 140, 150, 160, 170, or 180 minutes (and all times in between, such as 11 minutes, 12 minutes, 13 minutes, etc.). Thus, the disclosed package can be subjected to temperatures of about 200-450° F. for 10-180 minutes. In some embodiments, the conditions can include cooking the packaged product in a microwave, submersion in boiling or hot water, pop-up toaster, toaster oven, wok, broiler, conventional oven, convection oven, conventional grill, direct contact with a double-sided grill, and the like.

As used herein, the term “seal” refers to any bond of a first region of an outer film surface to a second region of an outer film surface, including heat or any type of adhesive material, thermal or otherwise. In some embodiments, the seal is formed by heating the regions to at least their respective seal initiation temperatures. The sealing can be performed by any one or more of a wide variety of means, such as, but not limited to, using a heat seal technique (e.g., melt-bead sealing, thermal sealing, impulse sealing, dielectric sealing, radio frequency sealing, ultrasonic sealing, hot air, hot wire, infrared radiation, and the like).

As used herein, the phrases “seal layer”, “sealing layer”, “heat seal layer”, and “sealant layer” refers to an outer layer or layers involved in the sealing of a film to itself, another layer of the same or another film, and/or another article that is not a film. In general, sealant layers employed in the packaging art have included the genus of thermoplastic polymers, including (but not limited to) thermoplastic polyolefin, polyamide, polyester, polyvinyl chloride, homogeneous ethylene/alpha-olefin copolymer, polypropylene, polypropylene copolymer, ethylene/vinyl acetate copolymer, and ionomer. In some embodiments, the sealant layer can be termed the “food contact layer.”

As used herein, the term “tie layer” refers to any internal film layer having the primary purpose of adhering two layers to one another. In some embodiments, tie layers can comprise any nonpolar polymer having a polar group grafted thereon, so that the polymer is capable of covalent bonding to polar polymers, such as polyamide and ethylene/vinyl alcohol copolymer. In some embodiments, tie layers can comprise at least one member of the group including, but not limited to, modified polyolefin, modified ethylene/vinyl acetate copolymer, anhydride grafted ethylene/methyl acrylate copolymer, homogeneous ethylene/alpha-olefin copolymer, and combinations thereof. In some embodiments, tie layers can comprise at least one member selected from the group including, but not limited to, anhydride modified grafted linear low density polyethylene, anhydride grafted low density polyethylene, homogeneous ethylene/alpha-olefin copolymer, anhydride grafted ethylene/methyl acrylate copolymer, and/or anhydride grafted ethylene/vinyl acetate copolymer.

All compositional percentages used herein are presented on a “by weight” basis unless designated otherwise.

### III. The Disclosed Film

III.A. Generally

The presently disclosed film can be multilayer or monolayer. Typically, however, the films employed will have two or more layers to incorporate a variety of properties, such as sealability, gas impermeability, and toughness into a single film. Thus, in some embodiments, the disclosed film comprises a total of from about 1 to about 20 layers; in some embodiments, from about 2 to about 12 layers; and in some embodiments, from about 3 to about 9 layers. Accordingly, the disclosed film can comprise 1, 2, 3, 4, 5, 6, 7, 8, 9, 10, 11, 12, 13, 14, 15, 16, 17, 18, 19, or 20 layers. One of ordinary skill in the art would also recognize that the disclosed film can comprise more than 20 layers, such as in embodiments wherein the film components comprise microlayering technology.

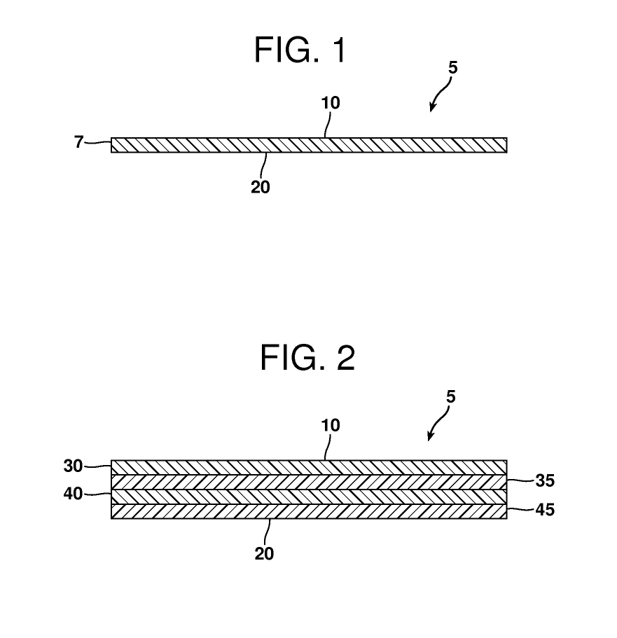

Accordingly, as illustrated in FIG. 1, in some embodiments, film 5 can be a monolayer film comprising core layer 7. Core layer 7 comprises interior (i.e., food-side) surface 10 that is proximate to or contacting a packaged product. Core layer 7 also comprises exterior surface 20 positioned opposite to interior surface 10. Thus, in some embodiments, film 5 can by itself be considered a food contact or sealant layer. As is readily understood to those having ordinary skill in the art of film manufacture, a greater number of layers can be included, depending on the specific attributes that are desired in such a film to suit the intended end-use application.

In some embodiments, film 5 can be multilayered (i.e., the film comprises at least two layers). For example, FIG. 2 illustrates a cross-sectional view of a multilayered film comprising 4 layers. In the embodiment depicted in FIG. 2, film 5 comprises interior surface 10 that is proximate to or contacting a packaged product and exterior surface 20 positioned opposite to interior surface 10. In addition, the film of FIG. 2 comprises sealant layer 30, first inner layer 35, second inner layer 40, and external layer 45. An “inner layer” is a layer that has both of its surfaces directly adhered to other layers of the multilayer film. It is noted that in some embodiments FIG. 2 is not drawn to scale and layers 30, 35, 40, and 45 can be of varying thicknesses compared to one another.

To this end, film 5 can have any total thickness desired, so long as the film provides the desired properties for the particular packaging operation in which the film is used, e.g., optics, modulus, seal strength, and the like. Final web thicknesses can vary, depending on processing, end use application, and the like. Typical thicknesses can range from about 0.1 to 20 mils; in some embodiments, about 0.3 to 15 mils; in some embodiments, about 0.5 to 10 mils; in some embodiments, about 1 to 8 mils; in some embodiments, about 1 to 4 mils; and in some embodiments, about 1 to 2 mils. Thus, in some embodiments, film 5 can have a thickness of about 10 mils or less; in some embodiments, a thickness of about 5 mils or less.

In some embodiments, film 5 can comprise printed product information such as (but not limited to) product size, type, name of manufacturer, cooking instructions, and the like. Such printing methods are well known to those of ordinary skill in the packaging art.

In some embodiments, film 5 can be substantially free of material precluded by a governmental agency for food use or food contact. For instance, the film can be substantially free of nylon-6/6,6, which in some applications and jurisdictions can have limited use as food contact material. Other materials precluded by a governmental agency are well known to those of ordinary skill in the art.

III.B. Sealant Layer 30

The sealant layer of film 5 comprises cellulose particles or other similar materials. In lieu of or in addition to cellulose particles, the sealant layer of film 5 can comprise materials similar to cellulose particles. Such similar materials can include (but are not limited to), ceramic particles, carbon nanotubes, and the like. For the sake of brevity, the term “cellulose particles” as used throughout the instant specification can equally correspond to the “similar materials” set forth above, as well as combinations of cellulose and such similar materials.

In some embodiments, the sealant layer can comprise a blend of nylon and cellulose particles. In some embodiments, the cellulose particles can comprise about 1 to 50%; in some embodiments, about 3 to 40%; in some embodiments, from about 5 to 25% of the total weight of the layer. Thus, in some embodiments, the cellulose particles can comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% of the total weight of the sealant layer. In some embodiments, the nylon component of the sealant layer can comprise about 50 to 99%; 60 to 97%; or 75 to 95% of the total weight of the layer, respectively. Thus, in some embodiments, the nylon component can comprise about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% of the total weight of the sealant layer.

In some embodiments, sealant layer 30 comprises a blend of nylon, cellulose particles, and non-stick additive. Such non-stick additives can include (but are not limited to) natural oils (such as soybean oil, canola oil, and the like), lecithin, colorants, flavorants, and the like. In some embodiments, the non-stick additives can comprise about 0.25 to 10% of the total weight of the layer. Thus, in some embodiments, the sealant layer can comprise about 0.25, 0.3, 0.35, 0.4, 0.45, 0.5, 0.55, 0.6, 0.65, 0.7, 0.75, 0.8, 0.85, 0.9, 0.95, 1, 1.25, 1.5, 1.75, 2, 2.25, 2.5, 2.75, 3, 3.25, 3.5, 3.75, 4, 4.25, 4.5, 4.75, 5, 5.25, 5.5, 5.75, 6, 6.25, 6.5, 6.75, 7, 7.25, 7.5, 7.75, 8, 8.25, 8.5, 8.75, 9, 9.25, 9.5, 9.75, or 10% non-stick additive, based on the total weight of the layer. In these embodiments, the cellulose particles can comprise about 1 to 50%; in some embodiments, about 3 to 40%; in some embodiments, from about 5 to 25% of the total weight of the layer and the nylon can comprise about 45 to 98.75%; in some embodiments, about 55 to 96%; in some embodiments, in some embodiments, about 74.75 to about 94.75%; and in some embodiments, about 74-94% of the total weight of the layer. All percentages given herein are by weight of the appropriate layer or blend. Alternatively or in addition, the non-stick additive can be added as a coating to film 5, as set forth in more detail below.

The amount of cellulose particles and/or non-stick additive present in sealant layer 30 imparts a cooked protein/non-adherence attribute to film 5 such that the layer (and thus the film) exhibits reduced or eliminated adherence to a packaged protein-containing food product. Thus, the amount of cellulose particles and/or non-stick additive in the sealant layer is desirably an amount effective to reduce the cooked protein adherence attributes of said layer of film 5. As would be apparent to one of ordinary skill in the art, effective amounts of cellulose or additive present in the sealant layer can vary with the composition and concentration of the selected food product (e.g., protein, fat, water, starch contents).

The cellulose particles, nylon component, and optionally the non-stick additive of the sealant layer can be mixed together in any conventional manner known to those of ordinary skill in the art. For example, in some embodiments, the cellulose particles can be mixed with the other polymer components of the layer (such as nylon) by tumble or dry blending, or by compounding in an extruder, followed by cooling. Masterbatching technology can also be employed. Alternatively or in addition, the components of the sealant layer can be mixed using an extensional flow mixer.

III.C. Additional Layers

In some embodiments, film 5 can comprise a barrier layer to serve as a barrier to one or more gases. Such barrier layers can include, but are not limited to, ethylene/vinyl alcohol copolymer, polyvinylidene chloride, polyalkylene carbonate, polyamide, polyethylene naphthalate, polyester, polyacrylonitrile, and combinations thereof, as known to those of skill in the art.

In some embodiments, film 5 can comprise an abuse layer. The abuse layer can be any film layer, so long as the film layer serves to resist abrasion, puncture, or other potential causes of reduction of package integrity or package appearance quality.

In some embodiments, the presently disclosed film can comprise a bulk layer that functions to increase the abuse resistance, toughness, and/or modulus of the film.

In some embodiments, film 5 can comprise one or more tie layers adapted for improving the adherence of one layer of said film to another layer.

The disclosed film and/or the sealant layer can include other additives commonly used with cook-in film compositions. For example, in some embodiments, the food-side external layer can include amounts of plasticizer effective to enhance the processibility of the film to a desired amount, for example from 2 to 12 weight percent, and from 4 to 10 weight percent; but can also include less than each of the following amounts of plasticizer: 20%, 15%, 12%, 10%, 8%, 6%, and 4%, each based on the weight of the sealant layer. In some embodiments, the amount of plasticizer is only that amount needed to provide the desired enhancement of processibility so that the attributes of film 5 are not further deteriorated.

Other useful additives that can be included within film 5 or sealant layer 30 include effective amounts of thermal stabilizer (e.g., a hydrogen chloride scavenger such as epoxidized soybean oil), lubricating processing aid (e.g., one or more acrylates), processing aids, slip agents, antiblock agents, and pigments. In some embodiments, the amount of additives present in the film is minimized in order that the film properties are not deteriorated.

### IV. Methods of Making Film 5

Film 5 can be constructed using any suitable process known to those of ordinary skill in the art, including (but not limited to) coextrusion, lamination, extrusion coating, and combinations thereof. See, for example, U.S. Pat. Nos. 6,769,227 to Mumpower; 3,741,253 to Brax et al.; 4,278,738 to Brax et al.; 4,284,458 to Schirmer; and 4,551,380 to Schoenberg, each of which is hereby incorporated by reference in its entirety.

For example, the disclosed film can be prepared by extrusion or coextrusion utilizing, for example, a tubular trapped bubble film process or a flat film (i.e., cast film or slit die) process. The film can also be prepared by extrusion coating. Alternatively, multilayer embodiments of the present film can be prepared by adhesively laminating or extrusion laminating the various layers. A combination of these processes can also be employed. Such processes are known to those of skill in the art.

Alternatively, in some embodiments, the polymer components of the film can be heated, for example, by use of an extruder. The cellulose particles and optionally the additive particles can then be added to the polymer components. The addition can occur before, during, or after the polymer components have been heated. In some embodiments, the combined materials can be mixed in an extensional flow mixer to construct a mixed composition having the cellulose particles (and optionally additives) dispersed in the matrix polymer. The mixed composition can then be formed into a film that is subsequently oriented. See, for example, U.S. Patent Application Publication No. 2009/0230223 and U.S. Pat. No. 7,468,404, the entire disclosures of which are hereby incorporated by reference.

### V. Use of the Disclosed Film

Film 5 can be formed into a package for containing and cooking a food product (i.e., film 5 is retortable). For example, suitable package configurations can include (but are not limited to) end-seal bags, side-seal bags, L-seal bags, pouches, and seamed casings (e.g., back-seamed tubes by forming an overlap or fin-type seal). Such configurations are known to those of skill in the art. Alternatively or in addition, film 5 can be tightly wrapped around a product by vacuum wrapping (using conventional vacuum wrapping equipment), shrink wrapping (e.g., by orienting the film during the film manufacturing process and thereafter heating the film, causing it to shrink tightly around the food product), and/or similar type conventional or non-conventional wrapping methods.

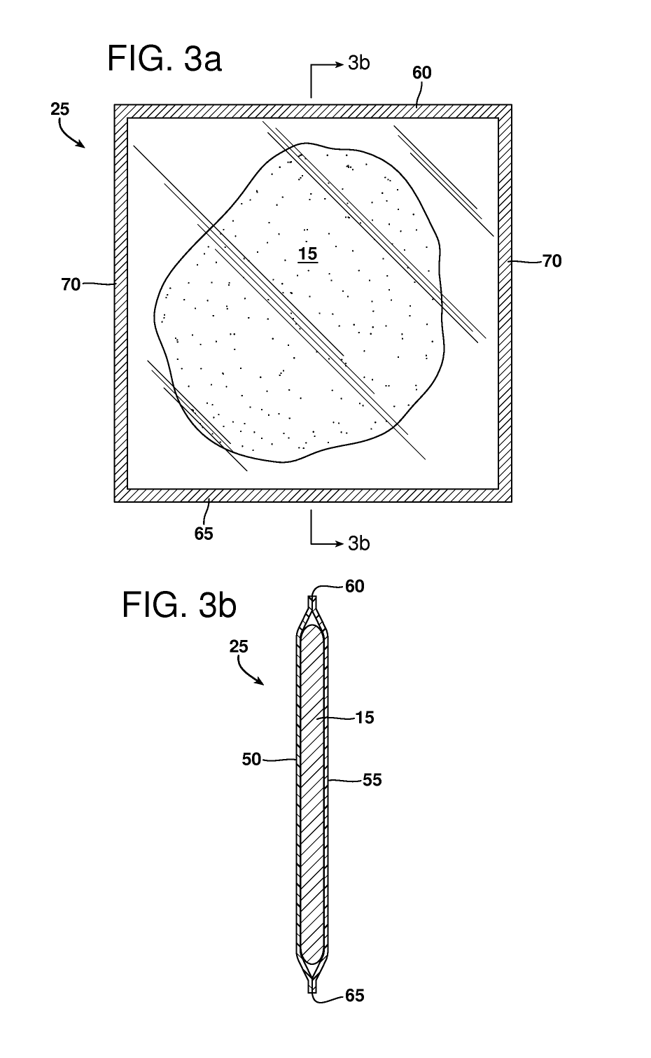

FIGS. 3a and 3b depict one embodiment of a package that can be used in accordance with the presently disclosed subject matter. Package 25 can be constructed from front film 50 and rear film 55. One of ordinary skill in the art can appreciate that in lieu of the front and rear sheets, a single sheet of film can be folded over and sealed. Front film 50 and rear film 55 can be sealed together around their edges to form top seal 60, bottom seal 65 and side seals 70. Although depicted as rectangular in shape in the Figures, package 25 can be constructed in any desired size and shape.

Seals 60, 65, and 70 can be constructed using any of a number of means well known in the art, including (but not limited to) the application of heat, pressure, and/or adhesives. In some embodiments, film 5 is capable of forming heat seals to itself that will not fail or delaminate after exposure to cook-in conditions, for example, temperatures of around 350° F. to 400° F. for up to about three hours.

Package 25 can be filled with product 15 using any of a wide variety of methods, including vertical form-fill-seal or horizontal form-fill-seal processes known to those of ordinary skill in the art. See, for example U.S. Pat. Nos. 5,228,531; 5,360,648; 5,364,486; 5,721,025; 5,879,768; 5,942,579; and 6,117,465, the entire disclosures of which are hereby incorporated by reference. In some embodiments, prior to filling package 25 with product, sealant layer 30 can be coated with non-stick additive on the surface that will be in contact with product 15 (i.e, surface 10 of film 5). Particularly, surface 10 can be coated with a thin layer of non-stick additive using any of a wide variety of methods known to those of ordinary skill in the food packaging art.

The product enclosed within the package can be cooked or retorted for an effective amount of time and at an effective temperature. To this end, package 25 (and the associated product) can be subjected to any of a wide variety of cooking appliances known in the art including (but not limited to) microwave, submersion in boiling or hot water, pop-up toaster, toaster oven, wok, broiler, conventional oven, convection oven, conventional grill, double-sided grill, and the like. For example, in some embodiments, the package can be cooked and/or heated directly on an indoor electric grill containing a double-sided cooking surface with a series of parallel ridges. One example of this type of appliance is the George Foreman Grill® (available from Applica Consumer Products, Inc., Miramar, Fla., United States of America). In this type of grill, two grill elements cook/grill the food on the top and the bottom sides simultaneously.

During the cooking process, the package is typically exposed to sufficient temperatures for a sufficient time to heat and/or cook product 15 as desired. For example, in some embodiments, the package can be exposed to temperatures ranging from 200° F. to 450° F.; in some embodiments, from 300° F. to 400° F.; and in some embodiments, from 350° F. to 400° F. In some embodiments, exposure to elevated temperatures can shrink the package tightly about product 15 as a result of heat shrinkage of film 5. Furthermore, during the cooking process, the package can be cooked or retorted for up to 12 hours. For example, in some embodiments, product 15 can be cooked for 10 minutes to 1 hour. As disclosed herein, in some embodiments, if the amount of cellulose particles blended into the sealant layer of film 5 is at least about 1%; in some embodiments, at least about 3%; and in some embodiments, at least about 5% of the total weight of the layer, the cooked food product will be precluded from adhering to the film. Alternatively or in addition, if the amount of cellulose particles blended into the sealant layer of film 5 is at least about 1, 3, or 5% of the total weight of the layer and the amount of non-stick additive is about 0.25 to about 10% of total weight of the layer, the cooked food product will be precluded from adhering to the film. Without being bound by any particular theory, in embodiments wherein non-stick additive is incorporated into film 5, it is believed that the additive permeates into the cellulose structure where it is retained until heating releases it. At such time, the non-stick additive assists in preventing product 15 from adhering to the sealant layer of film 5.

The film can be considered “non-adhering” or “not adhered” to a particular product (e.g., a protein-containing food) if the film does not appear (after unaided visual inspection of the film from a 12-inch distance) to have any amount of the cooked food product adhering or remaining attached to the film after the film has been stripped from the packaged, cooked food product. Alternatively, in some embodiments, film 5 can be considered “substantially non-adhering” such that less than 15% (which can include 0.5%, 1%, 2%, 3%, 4%, 5%, 6%, 7%, 8%, 9%, 10%, 11%, 12%, 13%, 14%, or 15%) of the total weight of the cooked food product remains attached to the film after the film has been stripped from the packaged, cooked food product. Thus, the presently disclosed subject matter includes a film comprising cellulose particles and optionally non-stick additive in the sealant layer, wherein the amount of cellulose particles and non-stick additive is effective to substantially preclude adherence of the sealant layer to the food product during retort conditions (i.e., 15% or less of the total weight of the cooked food product remains attached to the film after the film has been removed from the cooked food product).

The disclosed films have been described in connection with cook-in applications. However, it is to be understood that other applications for the films are also possible (such as, for example, medical applications). Accordingly, the subject disclosure should not be construed as being limited solely to food packages.

### VI. Advantages of the Disclosed Film

Film 5 advantageously reduces or eliminates adherence of the film to packaged food products during or after the cooking. Particularly, the presently disclosed subject matter comprises films wherein cellulose particles and optionally non-stick additive has been blended into the sealant layer of the film. In some embodiments, the amount of cellulose particles in the sealant layer is about 1% to about 50% of the total weight of the layer. In some embodiments, the amount of non-stick additive in the sealant layer is about 0.25 to 10% of the total weight of the layer. The cellulose particles and/or the non-stick additive are believed to effectively reduce or eliminate adhesion to the packaged product and associated product damage.

In addition, the cellulose particles and non-stick additive discussed herein are U.S. Food and Drug Administration (“FDA”) accepted high temperature materials. Accordingly, film 5 maintains FDA approval for high temperature cook-in applications.

Further, film 5 offers a cost-effective means to reduce adhesion of the film to a packaged product. That is, the cellulose particles and non-stick additives described herein above are comparatively inexpensive compared to other film materials used in the packaging art.

Despite the blending of cellulose particles and non-stick additives into the sealant layer of film 5, the film still can be effectively sealed using conventional sealing hardware and temperatures.

Also, the presently disclosed subject matter includes a reduction in the amount of film used. Particularly, prior art solutions to product-film adhesion has been to use an oversized package (i.e., larger than needed) to promote reduced contact with the product during cooking. Thus, the disclosed film solves the adhesion problem without having to oversize the package and thereby waste film.

Further, the presently disclosed subject matter eliminates the need to provide controlled venting of the cook-in package. Specifically, prior art solutions to product-film adhesion have been to use controlled venting of the cook-in package to balloon the film away from the product during cooking. Thus, the disclosed film solves the adhesion problem without requiring controlled venting, thereby simplifying the package design and saving money.

In addition, the presently disclosed package enhances the aesthetics of the packaged product. Particularly, the package provides reduced adhesion to the cooked product, thereby increasing consumer acceptable of the appearance of the cooked product.

### EXAMPLES

The following examples provide illustrative embodiments. In light of the present disclosure and the general level of skill in the art, those of ordinary skill can appreciate that the following examples are intended to be exemplary only and that numerous changes, modifications, and alterations can be employed without departing from the scope of the presently claimed subject matter.

Several film structures in accordance with the presently disclosed subject matter and comparatives are identified herein below.

TABLE 1
Resin Identification

| Material | Trade name Or | |
|---|---|---|
| Code | Designation | Source(s) |
| A | Ultramid C33 LN 01 | BASF Corporation |
| | | (Florham Park, New |
| | | Jersey, United States of |
| | | America) |
| B | Ultramid B40 LN01 | BASF Corporation |
| | | (Florham Park, New |
| | | Jersey, United States of |
| | | America) |
| C | Sicopas 448 | BASF Corporation |
| | | (Florham Park, New |
| | | Jersey, United States of |
| | | America) |
| D | NA 189 | Solutia, Inc. (St. Louis, |
| | | Missouri, United States of |
| | | America) |
| E | Vydyne 65A | Solutia, Inc. (St. Louis, |
| | | Missouri, United States of |
| | | America) |
| F | Grilon BM 20 SBG | EMS-Chemie, Inc. |
| | Natural | (Sumter, South Carolina, |
| | | United States of America) |
| G | MB50-011 | Dow Chemical Company |
| | | (Midland, Michigan, |
| | | United States of America) |
| H | Ultramid B33 01 | BASF Corporation |
| | | (Florham Park, New |
| | | Jersey, United States of |
| | | America) |
| I | CreaClear CC 200 LS | CreaFill Fibers Corp. |
| | | (Chestertown, Maryland, |
| | | United States of America) |
| J | Solka-Floc ® | International Fiber |
| | | Corporation (North |
| | | Tonawanda, New York, |
| | | United States of America) |
| K | Synpro ® Calcium | Ferro Corporation |
| | Stearate NF | (Walton Hills, Ohio, |
| | | United States of America) |
| L | Triton 20T | Omya, Inc. (Blue Ash, |
| | | Ohio, United States of |
| | | America) |
| M | HTP Ultra 5L | IMI Fabi, LLC (Benwood, |
| | | West Virginia, United |
| | | States of America) |
| N | G1016 | Spectrum Laboratory |
| | | Products, Inc. (Gardena, |
| | | California, United States |
| | | of America) |
| O | Ultramid B40 LN01 | BASF Corporation |
| | | (Florham Park, New |
| | | Jersey, United States of |
| | | America) |
| P | Ultramid B27 | BASF Corporation |
| | | (Florham Park, New |
| | | Jersey, United States of |
| | | America) |
| Q | Ultramid C33 01 | BASF Corporation |
| | | (Florham Park, New |
| | | Jersey, United States of |
| | | America) |

A is a nylon-6/66.
B is a nylon-6 with specific gravity of 1.12-1.16 and DSC melting point 220° C. (+/−10° C.).
C is an antiblock (silica in nylon-6) with antiblock agent (SiO₂ - ISO 15512) target of 6.0 wt. % and moisture content (ISO 3451-4) <0.12%.
D is a heat stabilizer with copper (I) iodide concentration of 1.39% and potassium iodide concentration of 9.8% in a nylon 6/66 carrier.
E is a nylon-66 with relative viscosity of 120 (+/−10), DSC melting point 260° C. (+/−3° C.) and density of 1.14.
F is a nylon-66/610 with specific gravity 1.09 and DSC melting point 205° C. (+/−5° C.).
G is a slip agent with density 1.05 g/cc, 47-53 wt % siloxane and low viscosity nylon-6 as carrier resin.
H is a polyamide-6 with melting point of 220° C. and density of 1.130 g/cm³.
I is DC powdered cellulose with an average fiber length of 155 micron, average fiber thickness of 1-2 micron, pH of 7 to 7.5, and loose density of greater than 60 g/L.
J is powdered cellulose with composed of beta-1,4-glucan unites and is white, odorless and flavorless.
K is calcium stearate produced from food grade, vegetable-derived stearic acid, with median particle size of 7.0 microns and 99.9% fineness (passing 325 mesh).
L is calcium carbonate (98.0% carbonate content) with density ISO 787/10) of 2.7 g/cm³, moisture content of less than 0.3%, pH of 9-10, and median diameter (D 50%) of 1.8 um.
M is powdered talc (98% talc) with melting point of greater than 1300° C. and relative density of 2.7-2.8 g/cm³.
N is glycerin (1,2,3-propanetriol) with boiling point 290° C., melting point 19° C., specific gravity of 1.2636, and vapor density of 3.17.
O is polyamide-6 with melting point 220° C. and density of 1.14 g/cm³.
P is a low viscosity nylon-6.
Q is a polyamide 6/66 with melting point of 196° C. and density of 1.13 g/cc.

TABLE 2
Film Identification

| | | | | Layer |
|---|---|---|---|---|
| | | | | Thickness |
| Film ID | Layer | Formulation | Volume % | (mils) |
| Film 1 | 1 | 71% A | 12.0 | 0.96 |
| | | 20% B | | |
| | | 8% C | | |
| | | 1% D | | |
| | 2 | 55% E | 25.0 | 2.0 |
| | | 25% B | | |
| | | 20% F | | |
| | 3 | 55% E | 43.0 | 3.44 |
| | | 25% B | | |
| | | 20% F | | |
| | 4 | 55% E | 20.0 | 1.6 |
| | | 24.3% B | | |
| | | 20% F | | |
| | | 0.7% G | | |
| Film 2 | | 11.1% I | | |
| | 1 | 0.317% K | 100 | 4.64 |
| | | 0.418% L | | |
| | | 0.27% M | | |
| | | 40% O | | |
| | | 47.94% P | | |
| Film 3 | | 20% J | | |
| | 1 | 80% H | 100 | 5.48 |
| Film 4 | | 35% I | | |
| | 1 | 65% P | 100 | 8.88 |
| Film 5 | | 20% I | | |
| | 1 | 80% P | 100 | 6.08 |
| Film 6 | | 27.7% I | | |
| | 1 | 4.5% L | 100 | 8.20 |
| | | 1.33% M | | |
| | | 1.86% N | | |
| | | 64.6% Q | | |

### Example 1

### Preparation of Films 1-6

Film 1, with the compositions and constructions shown in Table 2, was constructed by cast coextrusion.

Films 2-6, with the compositions and constructions shown in Table 2, were constructed as monolayer cast films.

### Example 2

### Preparation of Packages 1-21

Specifically, a DuPont Teijin Films™ nonforming ovenable film (Mylar® 852) was used to make a pouch having three edges heat sealed using an Impulse Sealer ((Model No. AIE-405HIM 16 inch., provided by American International Electric Inc., Whittier, Calif., United States of America) set at about 356° F. for about 7 seconds to seal the edge areas of the first layers of the superimposed sheets together. About 2 ounces of raw frozen tilapia filets was placed into the pouch. The fourth edge of the pouch was then heat sealed using the Impulse Sealer set at about 356° F. for about 7 seconds to form a closed package (Package 1) enclosing the tilapia.

Packages 2, 3, 4, 5, and 6 were made using films 2, 3, 4, 5, and 6 of Example 1, respectively, using the method set forth above for Package 1.

Package 7 was prepared using DuPont Teijin Films™ Mylar® 852 using the method set forth above for Package 1 and positioned such that the nylon surface of the film is on the inside (food contact side) of the package.

Package 8 was formed identically to Package 7, with the addition of coating the tilapia with Pam® Cooking Spray (available from ConAgra Foods, Inc., Omaha, Nebr., United States of America) prior to insertion into the package.

Package 9 was prepared with Film 1, using the method set forth above for Package 1.

Package 10 was formed identically to Package 9, with the addition of coating the tilapia with Pam® Cooking Spray prior to insertion into the package.

Packages 11, 12, 13, 14, and 15 were prepared using Films 2, 3, 4, 5, and 6, respectively, using the method set forth above for Package 1, and with the addition of coating the tilapia with Pam® Cooking Spray prior to insertion into the package.

Packages 16, 17, 18, 19, and 20 were formed identically to Packages 11, 12, 13, 14, and 15, respectively, with the substitution of about 2 ounces of frozen salmon fillet in place of the tilapia.

Package 21 was formed identically to Package 1, with the substitution of about 2 ounces of frozen salmon fillet in place of the tilapia, and with the addition of coating the salmon with Pam® Cooking Spray prior to insertion into the package.

Table 3 summarizes the contents and formation of Packages 1-21:

TABLE 3
Packages 1-21

| Package No. | Film | Protein | +Coating |
|---|---|---|---|
| 1 | DuPont Teijin Films ™ | Frozen tilapia fillet | No |
| | Mylar ® 852 (PET | | |
| | surface in contact with | | |
| | protein) | | |
| 2 | 2 | Frozen tilapia fillet | No |
| 3 | 3 | Frozen tilapia fillet | No |
| 4 | 4 | Frozen tilapia fillet | No |
| 5 | 5 | Frozen tilapia fillet | No |
| 6 | 6 | Frozen tilapia fillet | No |
| 7 | DuPont Teijin Films ™ | Frozen tilapia fillet | No |
| | Mylar ® 852 with nylon | | |
| | surface in contact with | | |
| | protein | | |
| 8 | DuPont Teijin Films ™ | Frozen tilapia fillet | Yes |
| | Mylar ® 852 with nylon | | |
| | surface in contact with | | |
| | protein | | |
| 9 | 1 | Frozen tilapia fillet | No |
| 10 | 1 | Frozen tilapia fillet | Yes |
| 11 | 2 | Frozen tilapia fillet | Yes |
| 12 | 3 | Frozen tilapia fillet | Yes |
| 13 | 4 | Frozen tilapia fillet | Yes |
| 14 | 5 | Frozen tilapia fillet | Yes |
| 15 | 6 | Frozen tilapia fillet | Yes |
| 16 | 2 | Frozen salmon fillet | Yes |
| 17 | 3 | Frozen salmon fillet | Yes |
| 18 | 4 | Frozen salmon fillet | Yes |
| 19 | 5 | Frozen salmon fillet | Yes |
| 20 | 6 | Frozen salmon fillet | Yes |
| 21 | DuPont Teijin Films ™ | Frozen salmon fillet | Yes |
| | Mylar ® 852 (PET | | |
| | surface in contact w/ | | |
| | protein) | | |

### Example 3

### Protein Adhesion of Packages 1-21

Packages 1-21 were individually placed on a George Foreman Grill® containing two horizontal heating plates and cooked at about 375° F. for about 6 minutes and 15 psi to cook the tilapia or salmon fillets.

### Example 4

### Package Adherence Observations

After cooking as set forth in Example 3, the packages were opened using a cutting utensil and the amount of cooked meat that adhered to the package film was observed. Particularly, each package was given a score from 1-5, with “1” representing an observation of about 0% film/meat adherence (based on the total weight of the meat), “2” representing an observation of about 1-5% film/meat adherence, “3” representing an observation of about 6-10% film/meat adherence, “4” representing an observation of about 11-15% film/meat adherence, and “5” representing an observation of 16% or more film/meat adherence. The scoring for each package is set forth in Table 3, below.

TABLE 3
Visual Adherence Scores

| Package No. | Score |
|---|---|
| 1 | 4 |
| 2 | 5 |
| 3 | 5 |
| 4 | 5 |
| 5 | 5 |
| 6 | 5 |
| 7 | 4 |
| 8 | 1 |
| 9 | 4 |
| 10 | 5 |
| 11 | 1 |
| 12 | 1 |
| 13 | 2 |
| 14 | 1 |
| 15 | 2 |
| 16 | 1 |
| 17 | 1 |
| 18 | 1 |
| 19 | 1 |
| 20 | 1 |
| 21 | 1 |

### CONCLUSIONS

As illustrated in Table 3, using cellulose blends ranging from 11% to 27.7% significantly reduced the protein adhesion when used in combination with the release agent (non-stick additive). Films made with nylon that did not have the cellulose fibers incorporated therein did not exhibit the reduction in adhesion, even when the release agent was used. However, films comprising PET showed improvement when the release agent was used.

What is claimed is:

1. A cook-in film comprising a sealant layer comprising:
a. between about 5% and 25% cellulose particles, based on the total weight of the layer, and
b. between about 75% and 95% nylon, based on the total weight of the layer;
wherein the amount of cellulose particles is effective to substantially preclude adherence of the sealant layer to a protein-containing product in contact with said layer in conditions of from about 200° F. to about 450° F. for about 10 minutes to about 180 minutes.

2. The film of claim 1, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/6I, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

3. The film of claim 1, wherein said protein-containing product comprises at least 40 weight % proteinaceous food.

4. A cook-in film comprising a sealant layer comprising:
a. between about 5% and 25% cellulose particles, based on the total weight of the layer;
b. between about 74% and 94% nylon, based on the total weight of the layer; and
c. between about 0.25% and 10% non-stick additive, based on the total weight of the layer;
wherein the amount of cellulose particles and non-stick additive is effective to substantially preclude adherence of the sealant layer to a protein-containing product in contact with said layer in conditions of from about 200° F. to about 450° F. for about 10 minutes to about 180 minutes.

5. The film of claim 4, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/6I, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

6. The film of claim 4, wherein said protein-containing product comprises at least 40 weight % proteinaceous food.

7. A package comprising a protein-containing product positioned inside the package, wherein said package comprises a cook-in film comprising a sealant layer comprising:
a. between about 5% and about 25% cellulose particles, based on the total weight of the layer; and
b. between about 75% and about 95% nylon, based on the total weight of the layer,
wherein the amount of cellulose particles is effective to substantially preclude adherence of the sealant layer to said protein-containing product in contact with said layer in conditions of from about 200° F. to about 450° F. for about 10 minutes to about 180 minutes.

8. The package of claim 7, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/6I, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

9. The package of claim 7, wherein said protein-containing product comprises at least 40 weight % proteinaceous food.

10. A package comprising a protein-containing product positioned inside the package, wherein said package comprises a cook-in film comprising a sealant layer comprising:
a. between about 5% and 25% cellulose particles, based on the total weight of the layer;
b. between about 74% and 94% nylon, based on the total weight of the layer; and
c. between about 0.25% and 10% non-stick additive, based on the total weight of the layer,
wherein the amount of cellulose particles and non-stick additive is effective to substantially preclude adherence of the sealant layer to said protein-containing product in contact with said layer in conditions of from about 200° F. to about 450° F. for about 10 minutes to about 180 minutes.

11. The package of claim 10, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/6I, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

12. The package of claim 10, wherein said protein-containing product comprises at least 40 weight % proteinaceous food.

13. A method of cooking a food product using a cook-in package, said method comprising:
a. preparing a protein-containing product;
b. packaging said protein-containing product in a cook-in package constructed from a film comprising a sealant layer comprising:
i. between about 5% and about 25% cellulose particles, based on the total weight of the layer; and
ii. between about 75% and about 95% nylon, based on the total weight of the layer;
c. sealing the package closed such that the protein-containing product is surrounded by said film; and
d. cooking the food product by subjecting the package to a temperature of from about 200° F. to about 450° F. for a period of from about 10 minutes to about 180 minutes.

14. The method of claim 13, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/6I, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

15. The method of claim 13, wherein said protein-containing product comprises at least 40 weight % proteinaceous food.

16. A method of cooking a food product using a cook-in package, said method comprising:
a. preparing a protein-containing product;
b. packaging said protein-containing product in a cook-in package constructed from a film comprising a sealant layer comprising:
i. between about 5% and about 25% cellulose particles, based on the total weight of the layer; and
ii. between about 74% and about 94% nylon, based on the total weight of the layer; and
iii. between about 0.25% and 10% non-stick additive, based on the total weight of the layer;
c. sealing the package closed such that the protein-containing product is surrounded by said film; and
d. cooking the food product by subjecting the package to a temperature of from about 200° F. to about 450° F. for a period of from about 10 minutes to about 180 minutes.

17. The method of claim 16, wherein said nylon is selected from the group comprising: nylon 6, nylon 66, nylon 69, nylon 610, nylon 612, nylon 4/6 nylon 6/66, nylon 6/69, nylon 6/610, nylon 66/610, nylon 6/12, nylon 6/12/66, nylon 6/66/610, nylon 6/12/66, nylon 69/66/6I, nylon 10/10, nylon 11, nylon 12, nylon 6/12, MXD6, MXD6/MXDI, 66/MXD10, PA-6I/6T, PA-6I, PA-MXDI, PA-6/MXDT/I, PA-6,6/6I, amorphous polyamide, and combinations thereof.

18. The method of claim 16, wherein said protein-containing product comprises at least 40 weight % proteinaceous food.
